(19) United States
(12) Patent Application Publication
(10) Pub. No.: US 2014/0156620 A1
(43) Pub. Date: Jun. 5, 2014

(54) ENHANCED ONLINE SEARCH

(71) Applicant: Mark Joseph Gardner, Warrington, PA (US)

(72) Inventor: Mark Joseph Gardner, Warrington, PA (US)

(73) Assignee: eBay Inc., San Jose, CA (US)

(21) Appl. No.: 13/706,071

(22) Filed: Dec. 5, 2012

(51) Int. Cl. G06F 17/30

(52) U.S. Cl. CPC G06F 17/30864
USPC 707/706

(57) ABSTRACT

A method of providing users of a search engine with enhanced search results is disclosed. An entering of a search term by a user at the search engine is identified. It is determined that the search term is relevant to a data item stored in a database of a networked system that is external from the search engine. It is identified that the search engine has generated a search results page for the user in response to the entering of the search term by the user. A user interface is embedded in the search results page that provides the user with an option to access the data item without navigating away from the search results page.

### TECHNICAL FIELD

This application relates generally to the technical field of internet searching and, in one specific example, to enhancing online search results that are presented to a user by integrating current data maintained by a network-based publication system into the search results.

### BACKGROUND

When a user uses an Internet search engine to perform an Internet search, the search engine typically generates search results for the user based at least partially on a ranking by the search engine of a relevancy of indexed web pages to keywords specified by the user. Then the search engine typically presents the search results to the user as links to the most relevant indexed web pages corresponding to the keywords. The search results often do not include web pages that are temporary in nature, such as web pages corresponding to auction-style listings of an item that is for sale on a network-based publication system (e.g., eBay or Craigslist). Furthermore, to perform an action with respect to the search results, the user must click on one of the links in the search results page to navigate to an additional web page (e.g., at a hosting site) that provides the user with the option to perform the action he is seeking to perform. For example, if a user seeking to purchase an iPhone on eBay enters a search for “iPhone eBay” at a search engine, the search engine may present the user with search results that include links to various web pages at eBay, such as a link to a landing page at eBay that relates to iPhones. In this case, the user must navigate to the landing page (and perhaps additional pages linked to from the landing page) at eBay before he can perform his intended action of purchasing the iPhone.

### BRIEF DESCRIPTION OF THE DRAWINGS

Some embodiments are illustrated by way of example and not limitation in the figures of the accompanying drawings in which:

FIG. 1 is a network diagram depicting a client-server system within which various example embodiments may be deployed;

FIG. 2 is a block diagram illustrating multiple applications that, in one example embodiment, are provided as part of the networked system 102 of FIG. 1;

FIG. 3 is a block diagram illustrating a plug-in that, in one example embodiment, is provided as part of networked system 152 of FIG. 1;

FIG. 4 is a flow chart illustrating an example method of configuring a search engine to enhance search results presented to a user;

FIG. 5 is a flow chart illustrating, an example method of allowing a user to perform an action with respect to a web site referenced on a search results page without requiring the user to navigate away from the search results page;

FIG. 6 is a flow chart illustrating an example method of allowing users to perform actions with respect to a first networked system based on search terms that the user enters with respect to a second networked system;

FIG. 7 is a flow chart illustrating an example method of allowing a user to request information from a database of a web site hosting a web page that is referenced from a search result page generated by a search engine;

FIGS. 8A-8C are screenshots illustrating example user interfaces for presenting enhanced search results to a user;

FIGS. 9A-9B are screenshots illustrating additional example user interfaces for presenting enhanced search results to a user;

FIGS. 10A-I0B are screenshots illustrating additional example user interfaces for presenting enhanced search results to a user; and

FIG. 11 is a block diagram of a machine in the example form of a computer system within which instructions for causing the machine to perform any one or more of the methodologies discussed herein may be executed.

### DETAILED DESCRIPTION

In the following description, for purposes of explanation, numerous specific details are set forth in order to provide an understanding of various embodiments of the inventive subject matter. It will be evident, however, to those skilled in the art that embodiments may be practiced without these specific details. Further, to avoid obscuring the inventive concepts in unnecessary detail, well-known instruction instances, protocols, structures, and techniques have not been shown in detail. As used herein, the term “or” may be construed in an inclusive or exclusive sense, the term “user” may be construed to include a person or a machine, and the term “interface” may be construed to include an application program interface (API) or a user interface.

In various embodiments, a method of providing users of a search engine with enhanced search results is disclosed. An entering of a search term by a user at the search engine is identified. It is determined that the search term is relevant to a data item stored in a database of a networked system that is external from the search engine. It is identified that the search engine has generated a search results page for the user in response to the entering of the search term by the user. A user interlace is embedded in the search results page that provides the user with an option to access the data item without navigating away from the search results page.

This method and other methods or embodiments disclosed herein may be implemented as a computer system having one or more modules (e.g., hardware modules or software modules). This method and other methods or embodiments disclosed herein may be embodied as instructions stored on a machine-readable medium that, when executed by a processor, cause the processor to perform the method.

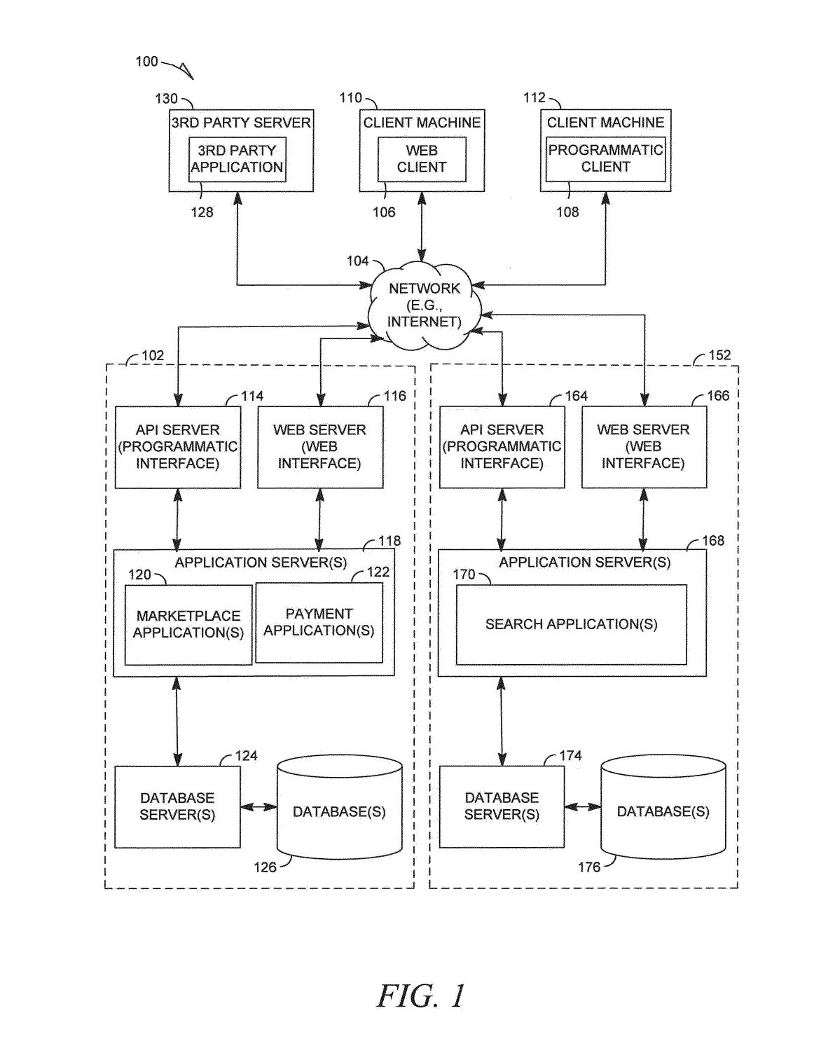

FIG. 1 is a network diagram depicting a client-server system 100, within which various example embodiments may be deployed. A networked system 102, in the example forms of a network-based publication system or other communication system, provides server-side functionality, via a network 104 (e.g., the Internet or Wide Area Network (WAN)) to one or more clients. FIG. 1 illustrates, for example, a web client 106 (e.g., a browser, such as the Internet Explorer browser developed by Microsoft Corporation of Redmond, Wash.) and a programmatic client 108 executing on respective client machines 110 and 112. Each of the one or more clients 106, 108 may include a software application module (e.g., a plug-in, add-in, or macro) that adds a specific service or feature to a larger system.

Within the networked system 102, an API server 114 and a web server 116 are coupled to, and provide programmatic and web interfaces respectively to. one or more application servers 118. The application servers 118 host one or more applications (e.g., marketplace application(s) 120 and payment application(s) 122). The application servers 118 are, in turn, shown to be coupled to one or more databases servers 124 that facilitate access to one or more databases or NoSQL or non-relational data stores 126.

An additional networked system 152, in the example forms of a search engine or other communication system, provides server-side functionality, via a network 104 to the one or more clients.

Within the networked system 152, an API server 164 and a web server 166 are coupled to, and provide programmatic and web interfaces respectively to, one or more application servers 168. The application servers 168 host one or more applications (e.g., search application(s) 170). The application servers 168 are, in turn, shown to be coupled to one or more databases servers 174 that facilitate access to one or more databases or NoSQL or non-relational data stores 176.

The applications 120. 122, and 170 may provide a number of functions and services to users who access the networked systems 102 and 152. While the applications are shown in FIG. 1 to form part of the networked systems 102 and 152, in alternative embodiments, the applications may form part of a service that is separate and distinct from the networked systems 102 and 152.

Further, while the system 100 shown in FIG. 1 employs a client-server architecture, various embodiments are, of course, not limited to such an architecture, and could equally well find application in a distributed, or peer-to-peer, architecture system, for example. The various applications could also be implemented as standalone software programs, which do not necessarily have computer networking capabilities. Additionally, although FIG, 1 depicts machines 130, 110, and 112 as being coupled to a networked system 102 and networked system 152, it will be readily apparent to one skilled in the art that machines 130, 110, and 112, as well as client 128, 106, and 108, may be coupled to multiple additional networked systems. For example, the clients 128, 106, and 108 may be coupled to multiple applications, such as payment applications 122 associated with multiple payment processors (e.g., Visa, MasterCard, and American Express).

The web client 106 accesses the various applications 120, 122, and 170 via the web interface supported by the web server 116 or the web server 166 respectively. Similarly, the programmatic client 108 accesses the various services and functions provided by the applications 120, 122, and 170 via the programmatic interface provided by the API server 114 and API server 164, respectively. The programmatic client 108 may, for example, perform batch-mode communications between the programmatic client 108 and the networked systems 102 and 152.

FIG. 1 also illustrates a third party application 128, executing on a third party server machine 130, as having programmatic access to the networked systems 102 and 152 via the programmatic interface provided by the APT server 114 and the API server 164, respectively. For example, the third party application 128 may, utilizing information retrieved from the networked systems 102 and 152, support one or more features or functions on a website hosted by the third party. The third party website may, for example, provide one or more promotional, social networking, or payment functions that are supported by the relevant applications of the networked system 102.

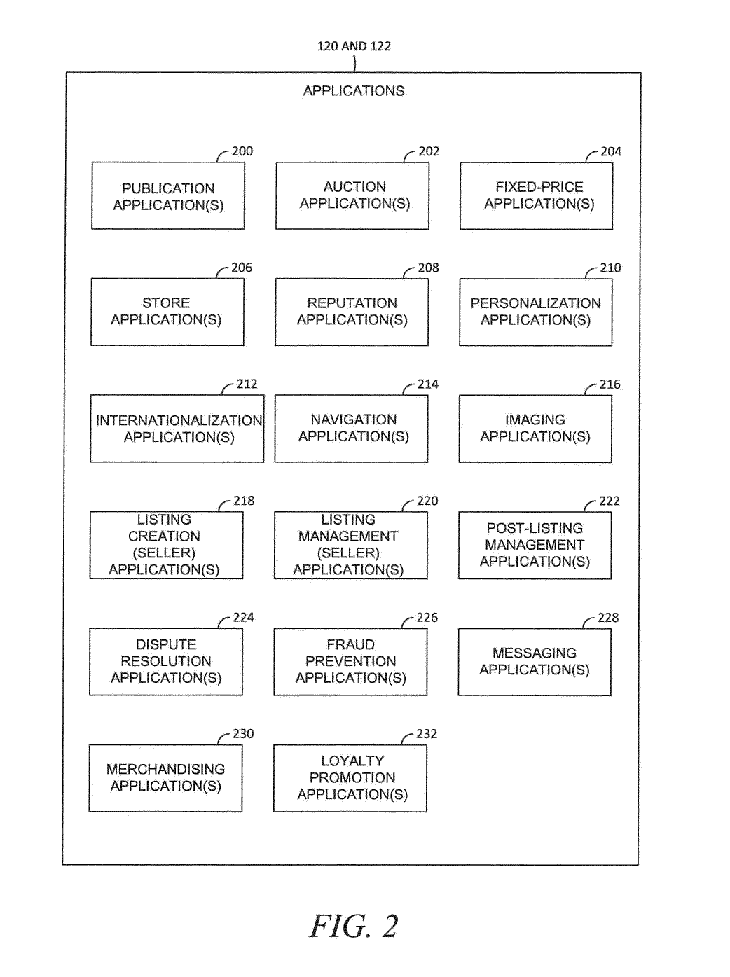

FIG. 2 is a block diagram illustrating multiple applications 120 and 122 that, in one example embodiment, are provided as part of the networked system 102. The applications 120 and 122 may be hosted on dedicated or shared server machines (not shown) that are communicatively coupled to enable communications between server machines. The applications 120 and 122 themselves are communicatively coupled (e.g., via appropriate interfaces) to each other and to various data sources, so as to allow information to be passed between the applications 120 and 122, or so as to allow the applications 120 and 122 to share and access common data. The applications 120 and 122 may furthermore access one or more databases 126 via the database servers 124 of FIG. 1.

The networked system 102 (FIG. 1) may provide a number of publishing, listing and price-setting mechanisms whereby a seller may list (or publish information concerning) goods or services for sale, a buyer can express interest in or indicate a desire to purchase such goods or services, and a price can be set for a transaction pertaining to the goods or services. To this end, in FIG. 2, the marketplace and payment applications 120 and 122 are shown to include at least one publication application 200 and one or more auction applications 202, which support auction-format listing and price setting mechanisms (e.g., English, Dutch, Vickrey, Chinese, Double, Reverse auctions etc.). The various auction applications 202 may also provide a number of features in support of such auction-format listings, such as a reserve price feature Whereby a seller may specify a reserve price in connection with a listing, and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Me, of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives, and features that are specific and personalized to a relevant seller.

Reputation applications 208 allow users that transact, utilizing the networked system 102, to establish, build, and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user (for example through feedback provided by other transaction partners) to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page at which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace, or may be customized (or internationalized) presentations of a common underlying marketplace. The networked system 102 may accordingly include a number of internationalization applications 212 that customize information (and/or the presentation of information) by the networked system 102 according to predetermined criteria (e.g., geographic, demographic or marketplace criteria). For example, the internationalization applications 212 may be used to support the customization of information for a number of regional websites that are operated by the networked system 102 and that are accessible via respective web servers 116 (FIG. 1).

Navigation of the networked system 102 may be facilitated by one or more navigation applications 214, in order to make listings available via the networked system 102 as visually informing and attractive as possible, the marketplace and payment applications 120 and 122 may include one or more imaging applications 216, which users may utilize to upload images for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers to conveniently author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller to conveniently provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of operations in an attempt to settle a dispute. In the event that the dispute cannot be settled via, the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 22$ are responsible for the generation and delivery of messages to users of the networked system 102. These messages may, for example, advise users regarding the status of listings at the networked system 102 (e.g., providing “outbid” notices to bidders during an auction process or providing promotional and merchandising information to users). Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IF (VoIP)) messages via the wired (e.g., the Internet), Plain Old Telephone Service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotion applications 232. For example, a buyer may earn loyalty or promotions points for each transaction established and/or concluded with a particular seller, and may be offered a reward for which accumulated loyalty points can be redeemed.

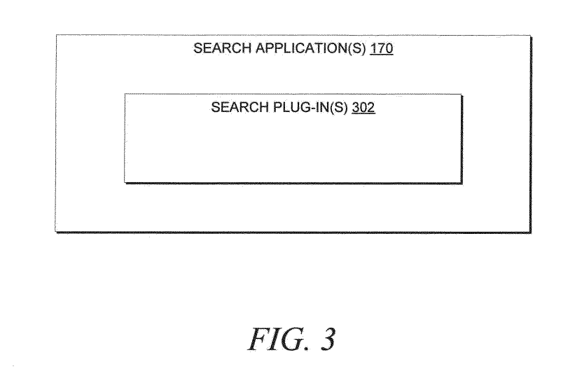

FIG. 3 is a block diagram illustrating the search application(s) 170 that are provided as part of networked system 152. In various embodiments, the search application(s) 170 are configured to allow a user to enter a search term, including one or more keywords, to perform an Internet search. The search application(s) 170 are further configured to generate and present search results corresponding to the search term. The search results may be determined from pages indexed by the search application(s) 170. The search application(s) may rank the search results according to an algorithm (e.g., a relevancy algorithm). The search application(s) 170 may present the results on a search results page as a list of links to the web pages that it determines are the most relevant to the search term entered by the user.

In various embodiments, the search application(s) 170 may include one or more search plug-in(s) 302. The search plug-in(s) 302 may be configured to enhance the search results presented to the user on the search results page. The search plug-in(s) 302 may be provided by one or more entities associated with a web site that hosts the web pages that are linked to from the search results page. For example, various search plug-in(s) 302 may be provided to the search application(s) 170 by eBay to enhance search results that include links to items listed on the eBay web site. The search plug-in(s) 302 may enable the search application(s) 170 of networked system 152 to interface directly with the application(s) 120 and 122 of the networked system 102 and vice versa (e.g., via the API servers 114 and 164 or the web servers 116 and 166.) Thus, the search plug-in(s) 302 may he configured to present additional information pertaining to the search results that would not otherwise be available to the user on the generated search results page. For example, the search plug-in(s) 302 may be configured to, based on the user entering a search term indicating that the user is interested in the item, present on the corresponding search results page detailed information about an ongoing auction for an item that is listed on the eBay web site. Or, based on the user entering a search term corresponding to an item that is listed on the eBay web site, the search plug-in(s) 302 may be configured to provide the user with an option on the search results page to enter a bid far or directly purchase an item that is listed on the eBay web site. Thus, the search plug-in(s) 302 may allow the user to access information or perform actions related to a search that the user has performed on the networked system 152 without requiring the user to navigate away from the search results page that is presented to the user by the search application(s) 170.

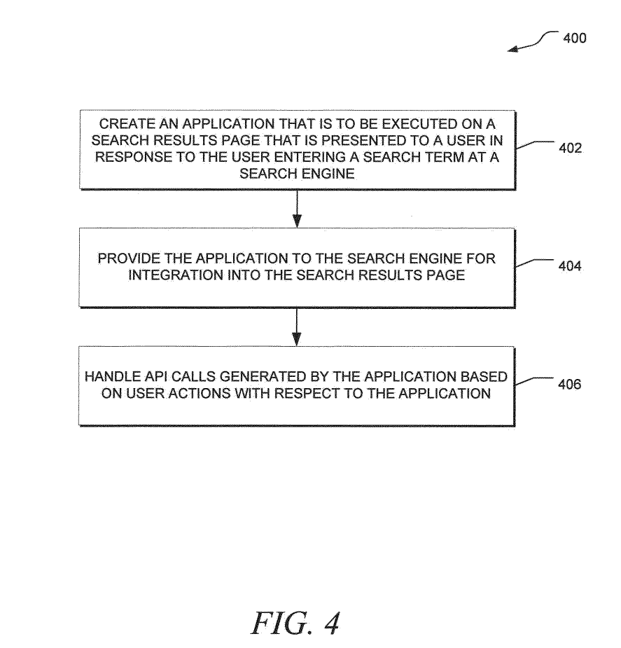

FIG. 4 is a flow chart illustrating an example method 400 of configuring a search engine to enhance search results presented to a user. At operation 402, an entity associated with the networked system 102 creates a lightweight application that is configured to allow the functionality of applications 120 and 122 of networked system 102 to be accessed from the search application(s) 170 of networked system 102. In various embodiments, the lightweight application is also configured to present a user interface to enable the user to interact with the applications 120 and 122 from within the search application(s) 170.

At operation 404, the entity associated with the networked system 102 provides the lightweight application to the search engine for integration into the search results page. In various embodiments, the lightweight application will have been designed and tested in a test environment and then submitted via an online submission tool to the search engine for integration into the search application(s) (e.g., as the plug-in 302).

At operation 406, the networked system 102 handles requests from the lightweight application (e.g., via the API servers 114 and 164 or the web servers 116 and 166) as the lightweight application executes on the networked system 152.

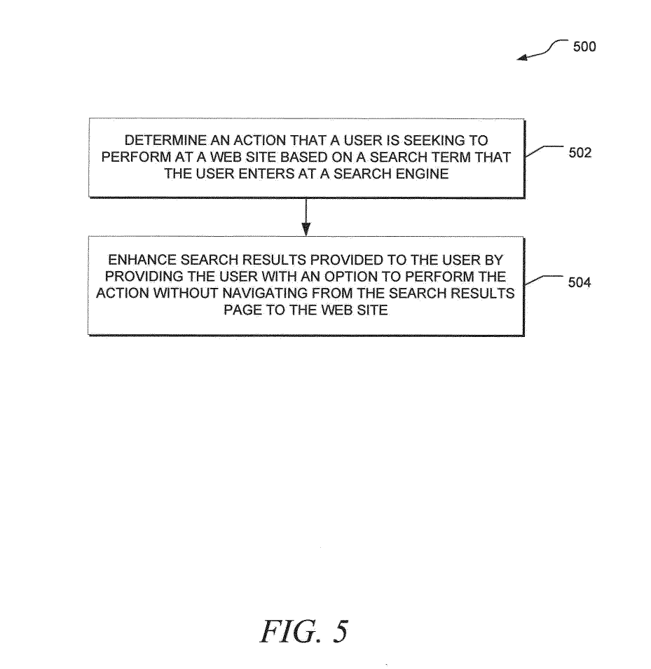

FIG. 5 is a flow chart illustrating an example method 500 of allowing a user to perform an action with respect to a web site referenced on a search results page without requiring the user to navigate away from the search results page. At operation 502, the plug-in(s) 302 may determine an action that a user is seeking to perform at a web site based on a search term that the user enters at the search engine, For example, the plug-in(s) 302 determine that the user is seeking to purchase an iPhone 3GS on the eBay web site based on the user entering a search term that includes “ebay iphone 3gs”.

At operation 504, the plug-in(s) 302 may enhance search results provided to the user (e.g., via the search application(s) 170) by providing the user with an option to perform the action without navigating from the search results page to the web site. For example, based on the user entering a search term that includes the keywords “ebay iphone 3gs”, the plug-in(s) 302 embed a user interface on the search results page that allows the user to view current listings of iPhone 3GS items on the eBay web site or place a bid for or directly purchase an iPhone 3GS item listed on the ebay web site.

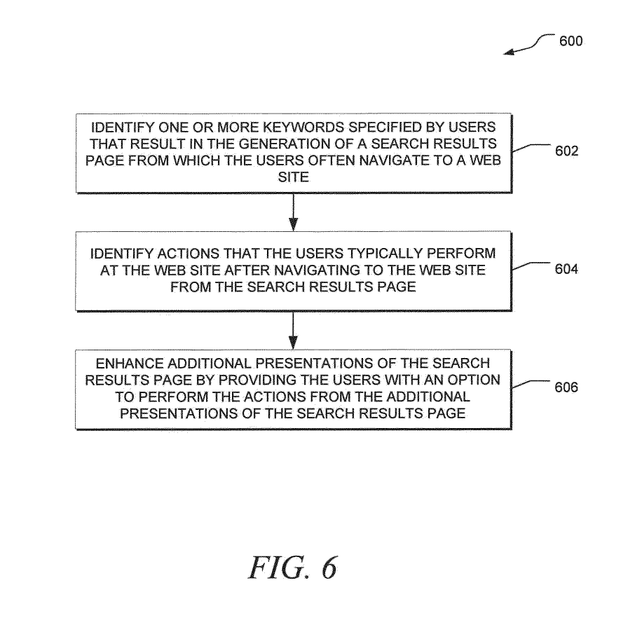

FIG. 6 is a flow chart illustrating an example method 600 of allowing users to perform actions with respect to a first networked system (e g., the networked system 102) based on search terms that the user enters with respect to a second networked system (e.g., the networked system 152).

At operation 602, the plug-in(s) 302 may identify one or more keywords specified by the users that resulted in the generation of the search results page from which the users navigate to a web site from a search engine. For example, the plug-in(s) 302 identify that users who specify a search term that includes the keyword “ebay” on the search engine web site (e.g., Google) often navigate from a search results page generated by the search engine to the eBay web site. Here, what constitutes ‘often’ may be based on a predetermined, configurable threshold Of the plug-in(s) 302. For example, the plug-in(s) 302 may be configured to identify a navigation away from the search results page to the web site as an “often” navigation based on the users navigating away from the search results page to the web site 50% of the time upon being presented with the search results page.

At operation 604, the, plug-in(s) 302 may identify one or more actions that the users typically perform at the web site after navigating to the web site from the search results page. For example, the plug-in(s) 302 may communicate with the application(s) 120 and 122 to discover actions that the users typically perform.

At operation 606, the plug-in(s) 302 may enhance subsequent presentations of the search results page corresponding to the search term to provide the users with an option to perform the identified actions from the search results page. For example, based on a determination that the users who are presented with a search results page corresponding to the term “ebay iPhone 3GS” navigate away from the search results page to eBay and then place a bid on an iPhone 3GS item, the plug-in(s) 302 may embed a user interface on the search results page corresponding to the search term “ebay iPhone 3GS” that allows the user to place a bid on the iPhone 3GS item without navigating, from the search results page to the eBay web site.

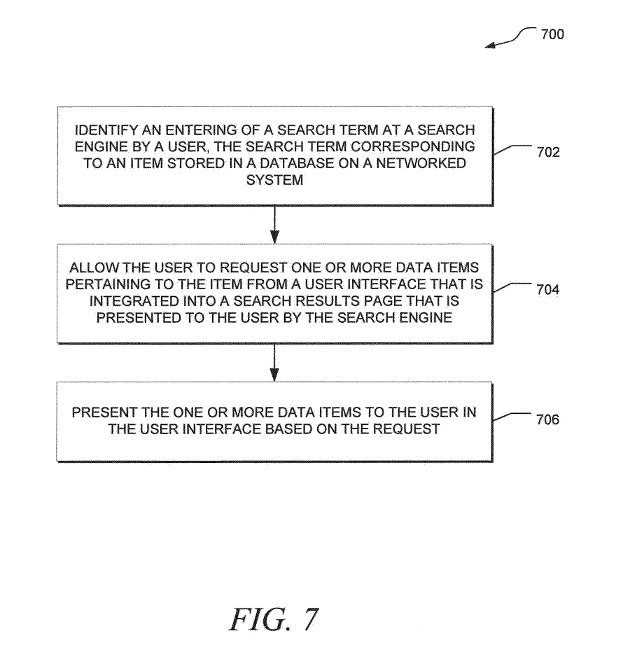

FIG. 7 is a flow chart illustrating an example method 700 of allowing a user to request information from a database of a web site hosting a web page that is referenced from a search result page generated by a search engine. At operation 702, the plug-fits) 302 may identify that a user of a search engine (e.g., networked system 152) has entered a search term that corresponds to an item in a database of an external system (e.g., networked system 102).

At operation 704, the plug-in(s) 302 may allow the user to request one or more data items pertaining to the item in the database. For example, the plug-in(s) 302 embed a user interface in the search results page that enables the user to collapse or expand fields of information that correspond to the item in the database. For example, if the item is an item that is listed on eBay, the plug-in(s) 302 may provide the user with the option to view information regarding the sellers of the item or pictures of the item that are included in listings of the item on the eBay web site.

At operation 706, the plug-in(s) 302 may present the one or more data items to the user based on the request of the user. For example, in response to a request from the user to view more results pertaining to an item, the plug-in(s) 302 may present a scrollable list of images of listings of similar items on the eBay web site. Thus, the plug-in(s) 302 may enable the user to access data that is available in the database of the external networked system that pertains to the search term, including information that is not presented in the search results page (e.g., as a result of the search engine not finding a corresponding web page containing the requested data during its indexing of the web site).

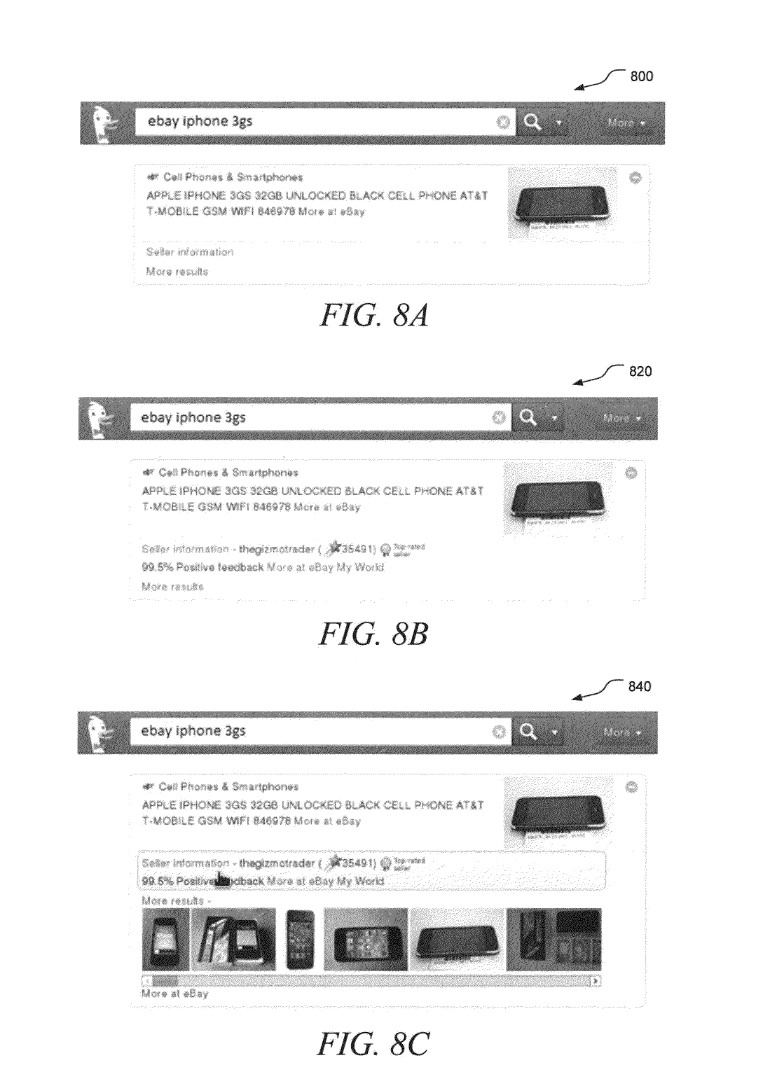

FIG. 8A is a screenshot illustrating an example user interface 800 for presenting enhanced search results pertaining to a search query entered by a user at a search engine. In various embodiments, the user interface 800 is embedded in a search results listing of a search engine (e.g., Google or DuckDuckGo). In this example, based on the user entering a search term that includes “ebay iphone 3gs”, the plug-in(s) 302 enhance the search results generated and presented to the user by the search engine by enabling the user to view information corresponding to an actual listing of an iPhone 308 on the eBay web site. The user interface enables the user to view a summary of the item as well as access additional information about the item, such as information pertaining to the seller associated with the listing or more results pertaining to the listing.

FIG. 8B is a screenshot illustrating an example user interface 820 of an expanded enhanced search result. In this example, the user has selected the “Seller information” link to view information about the seller of the item depicted in FIG. 8A.

FIG. 8C is a screenshot illustrating an example user interface 840 of an expanded enhanced search result. In this example, the user has selected the “More results” link to view listings of similar items on the eBay web site.

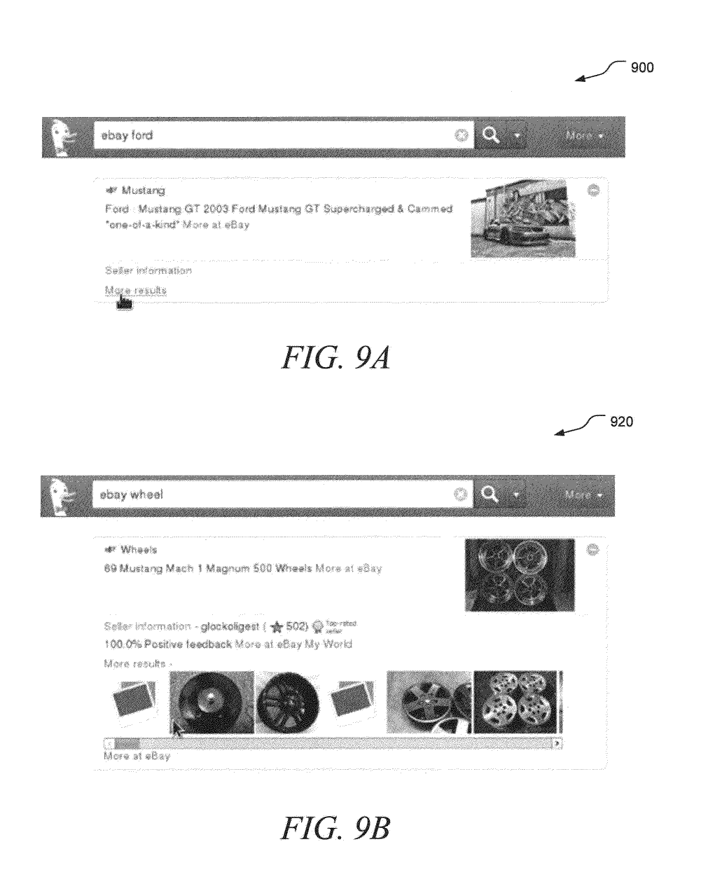

FIG. 9A is a screenshot illustrating an example user interface 900 of an additional enhanced search result, in this example, the user has entered a search term that includes the keywords “ebay ford”. In response, the user interface 900 presents a summary of a current listing of a Ford Mustang GT 2003 on the eBay web site.

FIG. 913 is a screenshot illustrating an example user interface 920 of an additional enhanced search result. In this example, the user has entered a search term that includes the keywords “ebay wheel”. In response, the user interface 920 presents a summary of a current listing of a Ford Mustang GT 2003 on the eBay web site. In this example, the user has expanded the enhanced search result by requesting the seller information and more results pertaining to the listing.

As with the user interfaces of FIG. 8A-8C, the user interfaces of FIG. 9A and FIG. 9B are embedded in the search results page such that the user need not navigate away from the search results page to view the enhanced search results provided by the web site hosting associated web pages that are listed on the search results page.

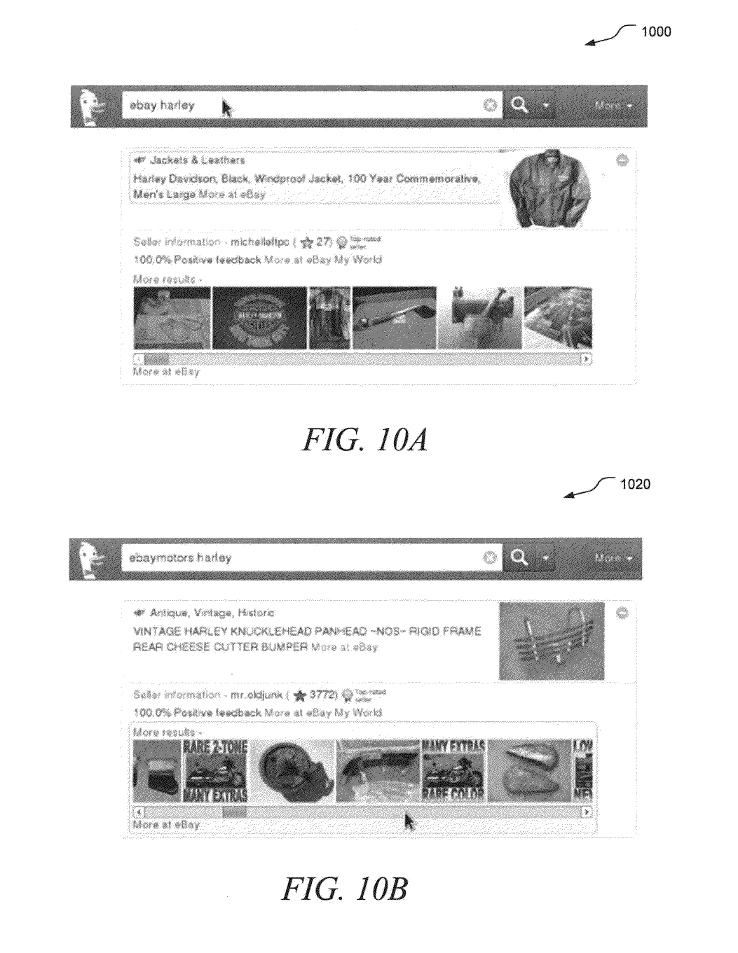

FIG. 10A and FIG. 10B are screenshots of example user interface 1000 and 1020, respectively. These example user interfaces depict how a user may select a particular domain within the external web site to which a search is directed. In user interface 1000, the user specifies the search term “ebay harley” and is thus presented with an enhanced search result corresponding to items listed on the eBay web site domain. In contrast, in user interface 1020, the user specifies the search term “ebaymotors harley” and is thus presented with an enhanced search result corresponding to items listed on the eBay Motors web site domain.

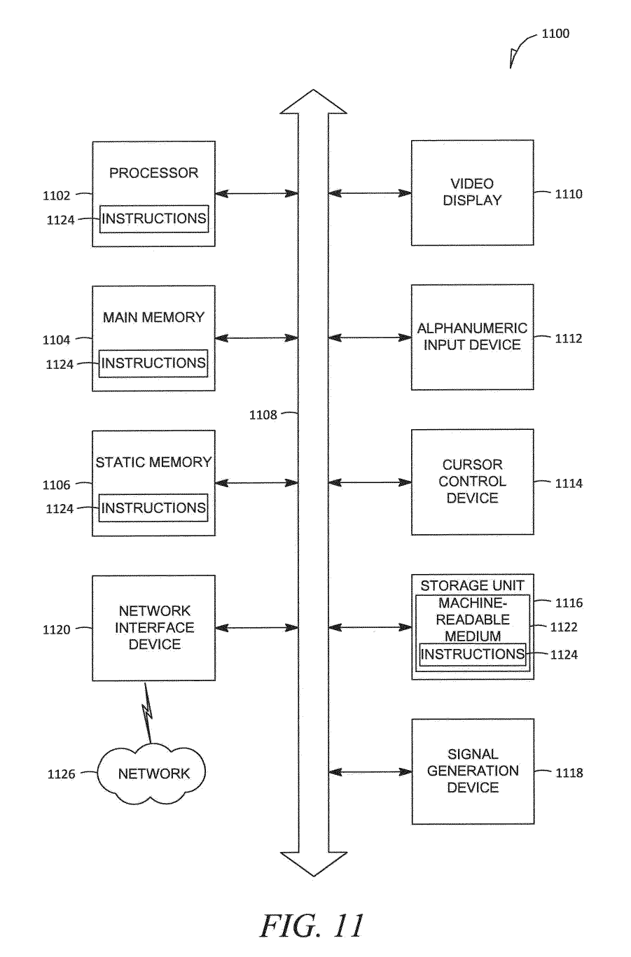

FIG. 11 is a block diagram of a machine in the example form of a computer system 1100 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor 1102 (e.g., a central processing unit (CPU), a graphics processing unit (GPU), or both), a main memory 1104 and a static memory 1106, which communicate with each other via a bus 1108. The computer system 1100 may further include a video display unit 1110 (e.g., a liquid crystal display (LCD) or a cathode ray tube (CRT)). The computer system 1100 also includes an alphanumeric input device 1112 (e.g., a keyboard), a user interface navigation (or cursor control) device 1114 (e.g., a mouse), a storage unit 1116, a signal generation device 1118 (e.g., a speaker), and a network interface device 1120.

The disk drive unit 1116 includes a machine-readable medium 1122 on which is stored one or more sets of data structures and instructions 1124 (e.g., software) embodying or utilized by any one or more of the methodologies or functions described herein. The instructions 1124 may also reside, completely or at least partially, within the main memory 1104 and/or within the processor 1102 during execution thereof by the computer system 1100, with the main memory 1104 and the processor 1102 also constituting machine-readable media. The instructions 1124 may also reside, completely or at least partially, within the static memory 1106.

While the machine-readable medium 1122 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also he taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and compact disc-read-only memory (CD-ROM) and digital versatile disc for digital video disc) read-only memory (DVD-ROM) disks.

The instructions 1124 may further be transmitted or received over a communications network 1126 using a transmission medium. In various embodiments, the network 1126 corresponds to the network 104 of FIG. 1. The instructions 1124 may be transmitted using the network interface device 1120 and any one of a number of well-known transfer protocols (e.g., Hyper Text Transfer Protocol (HTTP)), Examples of communication networks include a local area network (LAN), a WAN, the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising;
identifying an entering of a search term by a user at a search engine;
determining that the search term is relevant to a data item stored in a database of a networked system that is external from the search engine;
identifying that the search engine has generated a search results page for the user in response to the entering of the search term by the user; and
embedding, using a processor, a user interface in the search results page that provides the user with an option to access the data item without navigating away from the search results page.

2. The method of claim 1, wherein the search term corresponds to one of a product and a service that is associated with a listing on the networked system and the data item includes information about the listing.

3. The method of claim 2, wherein the information about the listing includes at least one of an image associated with the listing and information about a seller associated with the listing.

4. The method of claim 1, wherein the determining that the search term is relevant to the data item is based on an identification that an additional user navigated away from an additional search results page to access the data item on a web site of the networked system, the additional search results page having been generated by the search engine in response to an entering of the search term by the additional user.

5. The method of claim 1, wherein the embedding of the user interface is based on a determination that the search results include a link to a web page that is hosted on the external system.

6. The method of claim 1, further comprising embedding an additional user interface in the search results page that allows the user to perform an action with respect to the external system without navigating away from the search results page.

7. The method of claim 6, further comprising determining that the action is to purchase one of a product and a service that is listed on the networked system based on the search term including a reference to a web site that is hosted on the networked system.

8. A system comprising;
a processor-implemented search engine plug-in that is configured to:
identify an entering of a search term by a user at a search engine;
determine that the search term is relevant to a data item stored in a database of a networked system that is external from the search engine;
identify that the search engine has generated a search results page for the user in response to the entering of the search term by the user; and
embed a user interface in the search results page that provides the user with an option to access the data item without navigating away from the search results page.

9. The system of claim 8, wherein the search term corresponds to one of a product and a service that is associated with a listing on the networked system and the data item includes information about the listing.

10. The system of claim 9, wherein the information about the listing includes at least one of an image associated with the listing and information about a seller associated with the listing.

11. The system of claim 8, wherein the determining that the search term is relevant to the data item is based on an identification that an additional user navigated away from an additional search results page to access the data item on a web site of the networked system, the additional search results page having been generated by the search engine in response to an entering of the search term b the additional user.

12. . The system of claim 8, wherein the embedding of the user interface is based on a determination that the search results include a link to a web page that is hosted on the external system.

13. The system of claim 8, wherein the search engine plug-in is further configured to embed an additional user interface in the search results page that allows the user to perform an action with respect to the external system without navigating away from the search results page.

14. The system of claim 13, wherein the action is to purchase one of a product and a service that is listed on the networked system and that is relevant to the search term.

15. A non-transitory machine readable medium embodying a set of instructions that when executed by a processor, cause the processor to perform operations to match an advertisement to a user, the operations comprising:
identifying an entering of a search term by a user at a search engine;
determining that the search term is relevant to a data item stored in a database of a networked system that is external from the search engine;
identifying that the search engine has generated a search results page o the user in response to the entering of the search term by the user; and
embedding a user interface in the search results page that provides the user with an option to access the data item without navigating away from the search results page.

16. The non-transitory machine readable medium of claim 15, wherein the search term corresponds to one of a product and a service that is associated with a listing on the networked system and the data item includes information about the listing.

17. The non-transitory machine readable medium of claim 16, wherein the information about the list Mg includes at least one of an image associated with the listing and information about a seller associated with the listing.

18. The non-transitory machine readable medium of claim 15, wherein the determining that the search term is relevant to the data item is based on an identification that an additional user navigated away from an additional search results page to access the data item on a web site of the networked system, the additional search results page haying been generated by the search engine in response to an entering of the search term by the additional user.

19. The non-transitory machine readable medium of claim 15, wherein the embedding of the user interface is based on a determination that the search results include a link to a web page that is hosted on the external system.

20. The non-transitory machine readable medium of claim 15, the operations further comprising embedding an additional user interface in the search results page that allows the user to perform an action with respect to the external system without navigating away from the search results page.
